(19) United States
(12) Patent Application Publication
(10) Pub. No.: US 2018/0068282 A1
(43) Pub. Date: Mar. 8, 2018

(54) SYSTEMS AND METHODS FOR AGGREGATING TRANSFER OF FUNDS BETWEEN FINANCIAL AREAS

(71) Applicants: Dhruv Yogesh Patel, Mountain View, CA (US); Ravi Yogesh Patel, Mountain View, CA (US)

(72) Inventors: Dhruv Yogesh Patel, Mountain View, CA (US); Ravi Yogesh Patel, Mountain View, CA (US)

(21) Appl. No.: 15/696,774

(22) Filed: Sep. 6, 2017

Related U.S. Application Data
(60) Provisional application No. 62/384,068, filed on Sep. 6, 2016.

(51) Int. Cl. G06Q 20/10; G06Q 20/38

(52) U.S. Cl. CPC G06Q 20/10; G06Q 20/381

(57) ABSTRACT

Systems and methods aggregate transfer of funds between financial areas. A first server located within a first financial area receives a first transfer request to transfer funds from the first financial area to a second financial area. The first server communicates with a second server located in the second financial area to receive a second transfer request to transfer funds from the second financial area to the first financial area. A first exchange rate for the first transfer request and a second exchange rate for the second transfer request are determined and an aggregation amount is determined by aggregating the first and second transfer requests based upon the first and second exchange rates. Funds are sent to a recipient within the first financial area based upon the second transfer request and the second exchange rate and the aggregation amount is transferred between the first and second financial areas.

### RELATED APPLICATIONS

This application claims priority to U.S. Patent Application Ser. No. 62/384,068, titled “Systems and Methods for Aggregating Transfer of Funds Between Financial Areas,” filed Sep. 6, 2016, and incorporated herein by reference.

### BACKGROUND

A bank is typically used to transfer money between two entities in different countries. For example, a first person located within the United States of America wishes to send one thousand dollars to a second person located in India. The first person must use a first bank located in the USA to send a wire transfer for the one thousand dollars to a second bank located in India, preferably where the second person has an account. One of the banks will exchange the one thousand dollars into Indian rupees, such that the second person receives sixty-thousand rupees (assuming the exchange rate is one dollar to sixty rupees). Further, the first person typically incurs a charge for sending the transfer, and the second person incurs a charge for receiving the transfer.

### SUMMARY

In one embodiment, a method aggregates transfer of funds between financial areas. A first server located within a first financial area receives a first transfer request to transfer funds from the first financial area to a second financial area. The first server communicates with a second server located in the second financial area to receive a second transfer request to transfer funds from the second financial area to the first financial area. A first exchange rate for the first transfer request and a second exchange rate for the second transfer request are determined. An aggregation amount is determined by aggregating the first and second transfer requests based upon the first and second exchange rates. Funds are sent to a recipient within the first financial area based upon the second transfer request and the second exchange rate and the aggregation amount is transferred between the first and second financial areas.

In another embodiment, a method aggregates transfer of funds between financial areas. A first server located within a first financial area receives a first transfer request to transfer funds to a second financial area, the first transfer requests defining a first transfer amount and a first exchange rate. A second server located within the second financial area receives a second transfer request to transfer funds to the first financial area, the second transfer request defining a second transfer amount and a second exchange rate. The first transfer request is matched to the second transfer request based upon the first exchange rate and the second exchange rate. A first send component and a first receive component are generated for the first transfer request and a second send component and a second receive components are generated for the second transfer request. An aggregation amount is determined based upon the first and second send components and the first and second receive components. Funds are transferred within the first area corresponding to the first send component and the second receive component, and funds are transferred within the second area corresponding to the second send component and the first receive component. The aggregation amount is transferred between the first and second areas.

In another embodiment, a wallet server aggregates transfer of funds between a first financial area and a second financial area. The wallet server includes a processor and a memory communicatively coupled with the processor. The wallet server also includes a transfer splitter implemented as machine readable instructions stored within the memory and executed by the processor to split each received transfer request into a send component and a receive component. The transfer request requests transfer of funds between the first and second financial areas. The wallet server also includes an aggregator implemented as machine readable instructions stored within the memory and executed by the processor to: match exchange rates between the first financial area and the second financial area; and aggregate send components and receive components within the first financial area. The wallet server also includes a transfer manager implemented as machine readable instructions stored within the memory and executed by the processor to: balance the received transfers between the first and second financial areas; complete transfers deliverable within the first financial area; and settle a balancing aggregation amount with the second financial area.

### BRIEF DESCRIPTION OF THE FIGURES

FIG. 1 shows one exemplary system for aggregating transfer of funds between financial areas, in embodiments.

FIG. 2 shows the server of FIG. 1 in further exemplary detail.

FIG. 3A shows transfer of FIG. 1 in further exemplary details and illustrates generation of a send component and a receive component therefrom, in an embodiment.

FIG. 3B shows the ledger of FIG. 2 in further exemplary detail.

FIG. 4 shows one example scenario where transfers to and from each entity are further subdivided.

FIG. 5A shows a first server of FIG. 4 further configured with a transfer divider.

FIGS. 5B-D show example data of the transfer requests of FIG. 4 and corresponding send components and receive components.

FIG. 6 shows the second server of FIG. 4 further configured with a transfer divider.

FIG. 7 shows the ledger of FIG. 5A in further exemplar detail.

FIG. 8 shows the server of FIG. 5A further configured with an exchange engine, in an embodiment.

FIG. 9 is a flowchart illustrating one exemplary method for aggregating transfer of funds between financial areas, in an embodiment.

### DETAILED DESCRIPTION OF THE EMBODIMENTS

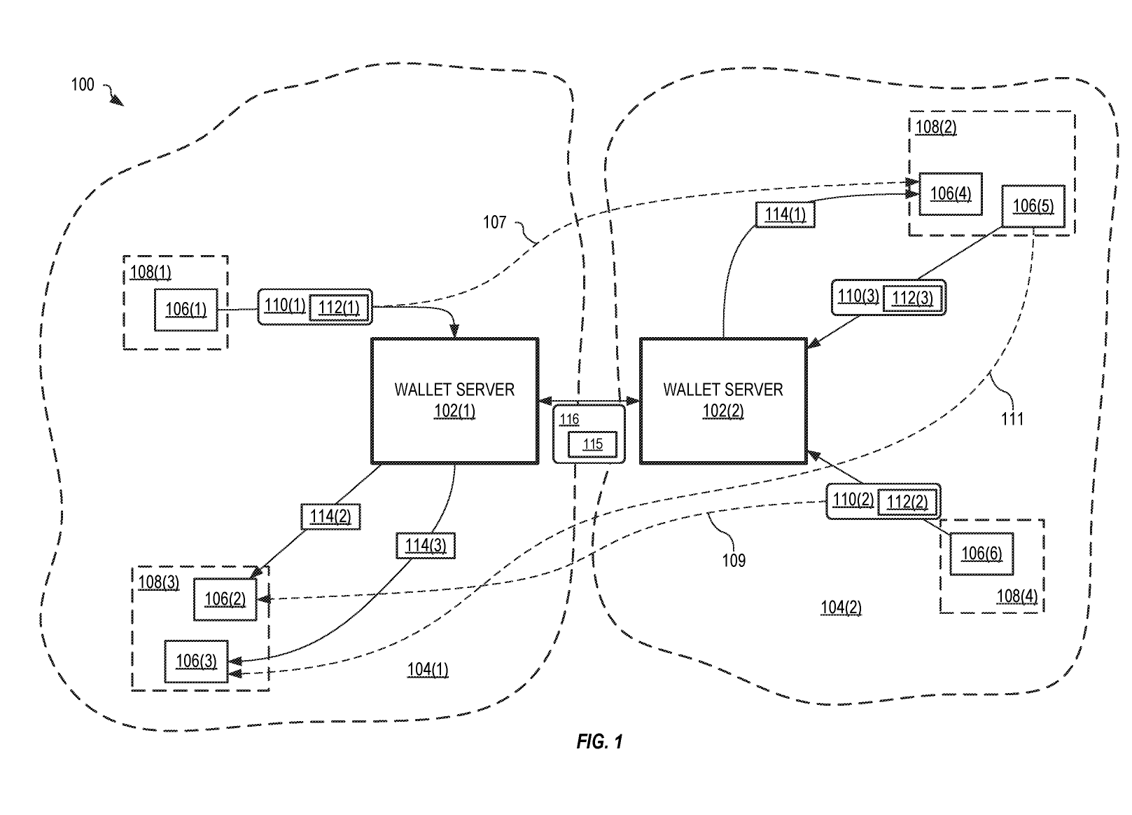

FIG. 1 shows one exemplary system 100 for aggregating transfer of funds between financial areas. System 100 includes a first wallet server 102(1) located within a first financial area 104(1), and a second wallet server 102(2), located within a second financial area 104(2). Financial areas 104 may each represent a country or vicinity that has its own financial currency. For example, financial area 104(1) may represent the United States of America, using the American Dollar for its currency, and financial area 104(2) may represent India, using the Rupee for its currency. The following example assumes a constant exchange rate of one US dollar to sixty Rupees, unless otherwise stated.

Second wallet server 102(2) is in communication with first wallet server 102(1) via a wired or wireless connection (e.g., the Internet or other wired digital communication medium) such that wallet servers 102 cooperate to facilitate concurrent transfer of funds between entities within financial area 104(1) and entities within financial area 104(2) with reduced fund transfer between each financial area. That is, the funds transferred between each financial area 104 is less than the sum of the funds transferred between the entities.

A plurality of first entities 106(1)-(3) are located within financial area 104(1). Entity 106(1) utilizes a financial institution 108(1) and entities 106(2) and 106(3) both utilize financial institution 108(3). A plurality of second entities 106(4)-(6) are located within financial area 104(2). Entities 106(4) and 106(5) utilize financial institution 108(2), and entity 106(6) utilizes financial institution 108(4). Entities 106 may each represent one of a person, a company, an organization, and so on. Financial institutions 108 may each represent one of a bank, a building society, a credit union, and so on.

In one example of operation, entity 106(1), in area 104(1), wishes to transfer, conceptually illustrated as dashed line 107, funds 112(1) (e.g., five hundred US dollars or thirty-thousand Rupees) to entity 106(4) in area 104(2). At the same time, entity 106(6) in area 104(2) wishes to transfer, conceptually illustrated as dashed line 109, funds 112(3) (e.g., six thousand Rupees or one-hundred dollars) to entity 106(2) in area 104(1), and entity 106(5) in area 104(2) wishes to transfer, conceptually illustrated as dashed line 111, funds 112(3) (e.g., eighteen thousand Rupees or three-hundred dollars) to entity 106(3) in area 104(1). Accordingly, entity 106(1) sends transfer 110(1) including funds 112(1) to server 102(1) for transfer to entity 106(4); entity 106(6) in area 104(2) sends a transfer 110(2) including funds 112(3) to server 102(2) for transfer to entity 106(2); and entity 106(5) sends a transfer 110(3) including funds 112(3) to server 102(2) for transfer to entity 106(3).

Each transfer 110 is received within an aggregation period and servers 102(1) and 102(2) cooperate to aggregate fund transfers within each area 104(1) and 104(2) to minimize fund transfers between areas 104(1) and 104(2). For example, having received funds 112(2) from entity 106(6) and funds 112(3) from entity 106(5), server 102(2) sends funds 114(1) (e.g., thirty-thousand Rupees corresponding to funds 112(1) of transfer 110(1)) to entity 106(4), server 102(1), having received funds 112(1) from entity 106(1), sends funds 114(2) (e.g., one-hundred dollars corresponding to funds 112(2) of transfer 110(2)) to entity 106(2) and sends funds 114(3) (e.g., three-hundred dollars corresponding to funds 112(3) of transfer 110(3)) to entity 106(3), and, to balance the transfers for the aggregation period, a balancing aggregation amount 115 (i.e., a balance of one-hundred dollars or six-thousand Rupees) is sent from server 102(1) to server 102(2) as aggregation transfer 116. Thus, three conventional transfers between areas 104(1) and 104(2) are reduced to a single smaller aggregation transfer 116 between areas 104(1) and 104(2).

Although this and the following examples show transfers between two financial areas 104 and aggregation thereof, transfers and aggregation may be implemented for multiple financial areas, where each financial area has a wallet server 102 that communicates with wallet servers of the other financial areas.

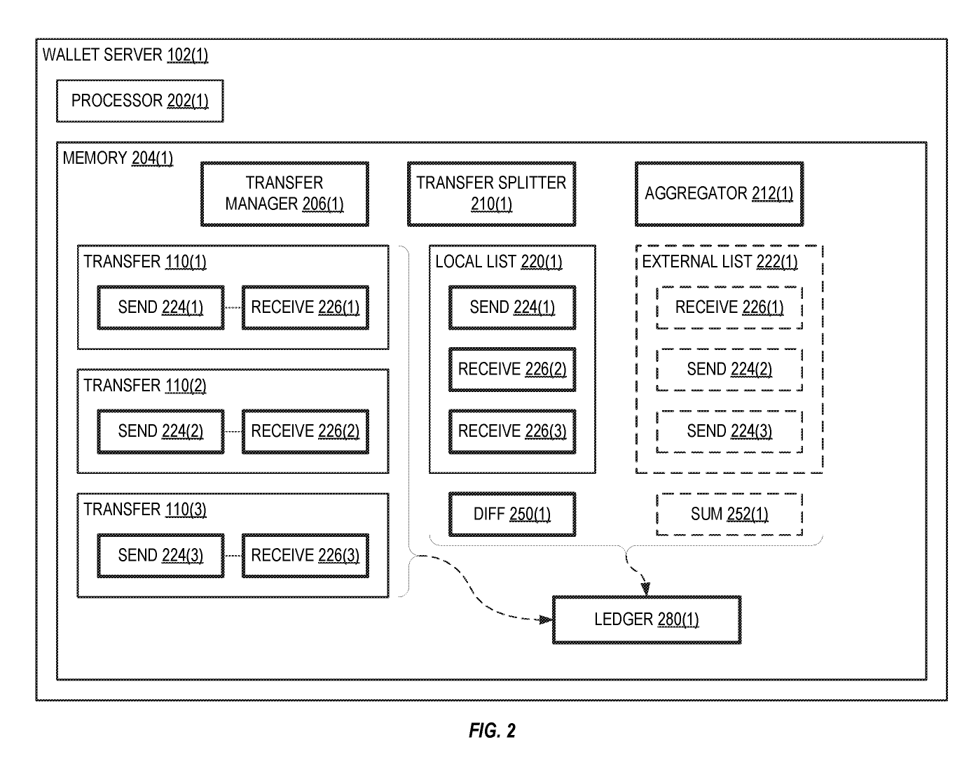

FIG. 2 shows wallet server 102(1) of FIG. 1 in further example detail. Wallet server 102(2) is similar. Wallet server 102(1) includes a processor 202(1) that is communicatively coupled to a memory 204(1). Server 102(1) may be implemented as one or more networked computers, as known in the art. Processor 202(1) may represent one or more digital processors, and memory 204(1) may represent one or more of RAM, ROM, FLASH, magnetic memory, and optical memory. Server 102(1) includes a transfer manager 206(1), implemented as machine readable instructions stored in memory 204(1) and executable by processor 202(1) that receives and manages transfers 110 within server 102(1). For example, transfer manager 206(1) may communicate, via one or more networks (e.g., the Internet), with wallet server 102(2) to implement and coordinate functionality of server 102(1) as described herein. Server 102(1) includes a transfer splitter 210(1), implemented as machine readable instructions stored in memory 204(1) and executable by processor 202(1), that is invoked from transfer manager 206(1) to split transfer 110(1) into a send component 224(1) and a receive component 226(1). Similarly, server 102(2) splits transfer 110(2) into send component 224(2) and receive component 226(2), and splits transfer 110(3) into send component 224(3) and receive component 226(3). Servers 102(1) and 102(2) (e.g., using transfer managers 206) exchange information of send components 224 and receive components 226 for the current aggregation period.

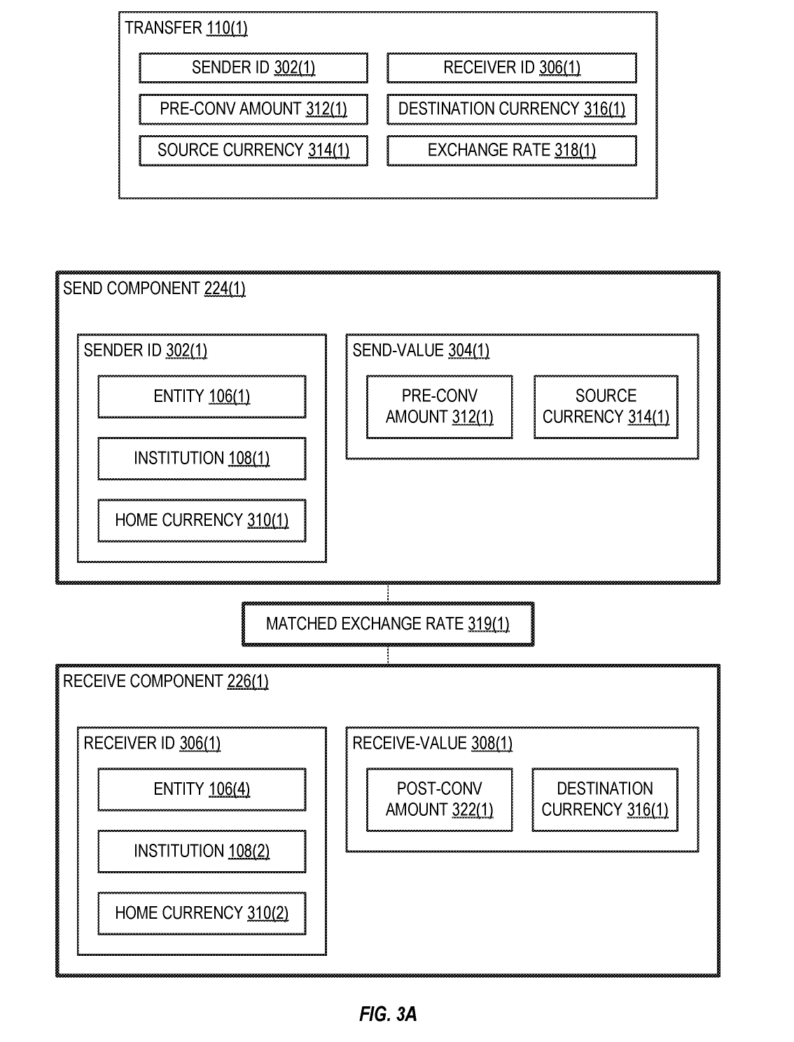

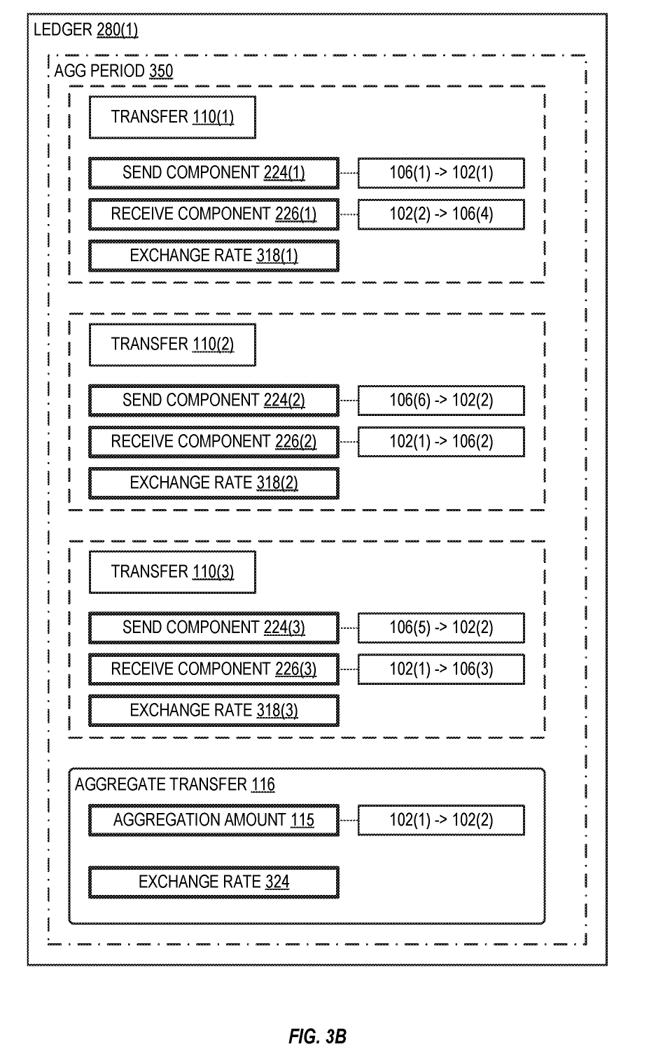

FIG. 3A shows transfer 110(1) in further exemplary details and illustrates generation of send component 224(1) and receive component 226(1) therefrom. Transfer 110(1) includes a sender ID 302(1) (e.g., entity 106(1)), a receiver ID 306 (e.g., entity 106(4)), a pre-conversion amount 312(1) (e.g., five hundred US dollars), a source currency 314(1) (e.g., US dollars), a destination currency 316(1) (e.g., Rupees), and an exchange rate 318(1) (e.g., one dollar to sixty Rupees). Transfer 110(1) may include other information without departing from the scope hereof. For example, transfer 110(1) may identify financial institutions 108(1) and 108(2) and financial areas 104(1) and 104(2) of entities 106(1) and 106(4), respectively.

Transfer splitter 210(1) processes transfer 110(1) and generates send component 224 to include sender ID 302(1) (e.g., identifying entity 106(1), and optionally institution 108(1) and a home currency 310(1)) and a send-value 304(1) that defines pre-convert amount 312(1) and source currency 314(1). Transfer splitter 210(1) processes transfer 110(1) and generates receive component 226 to include receiver ID 306(1) (e.g., identifying entity 106(4), institution 108(2) and a home currency 310(2)) and a receive value 308(1) defining post-convert amount 322(1) and destination currency 316(1). In the example of transfer 110(1), pre-conversion amount 312 is five-hundred and source currency 314(1) is US dollars. Source currency 314(1) is likely to be the same as home currency 310(1), but need not be. Receiver-value 308(1) may not be completed until transfer 110(1) is matched to at least one other transfer 110 in the identified destination currency 316(1). Although transfer 110(1) defines an exchange rate 318(1), this is a desired exchange rate of entity 106(1) and may not be the same as a final conversion exchange rate.

As shown in FIG. 2, server 102(1) also includes an aggregator 212(1), implemented as machine readable instructions stored in memory 204(1) and executable by processor 202(1), that separates each send component 224 and each receive component 226 for the current aggregation period to form a local list 220(1) and optionally an external list 222(1) based upon whether each component is to be actioned (i.e., within either sever 102(1) or within server 102(2)). Continuing with the example of FIG. 1, local list 220(1) includes send component 224(1) and receive components 226(2) and 226(3), since these portions of each transfer 110 are handled by server 102(1) within financial area 104(1). External list 222(1), if created, includes receive component 226(1) and send components 224(2) and 224(3), since these portions of the transfers 110 are handled within external server 102(2). Server 102(2) builds lists 220(2), 222(2) with complimentary components, in this example.

Aggregator 212(1) matches exchange rates 318(1) to exchange rates 318 of transfers 110(2) and (3) received within server 102(2) and determines an agreed exchange rate 319(1), and uses agreed exchange rate 319(1) to determine post-convert amount 322(1) of receive value 308(1). Receive values 308 of receive components 226(2) and 226(3) are similarly determined. Aggregator 212(1) then sums send-values 304 of send components 224 within local list 220(1) and subtracts receive-values 308 of receive components 226 within local list 220(1) to determine difference 250(1). Where difference 250(1) is positive, aggregator 212(1) initiates aggregation transfer 116 to send aggregation amount 115 corresponding to difference 250(1) (e.g., after conversion of difference 250(1) into the appropriate currency) to server 102(2). Where difference 250(1) is negative, aggregator 212(1) expects to receive aggregation transfer 116 with aggregation amount 115 from server 102(2).

Server 102(1) then actions the components 224, 226 within local list 220(1), updating a ledger 280(1) for each transfer 110. Continuing with the example of FIG. 1, funds 112(1) received by server 102(1) from entity 106(1) correspond to send component 224(1), server 102(1) sends funds 114(2) to entity 106(2) corresponding to receive component 226(2), and server 102(1) sends funds 114(3) to entity 106(3) corresponding to receive component 226(3). Then, based upon difference 250(1), server 102(1) initiates aggregation transfer 116 to transfer aggregation amount 115 to server 102(2).

Thus, only aggregation amount 115 (e.g., one hundred dollars) is actually converted into a different currency and transferred between area 104(1) and area 104(2), rather than the three requested transfers 110. As appreciated, the greater the number of transfers aggregated within the aggregation period, the smaller the value of aggregation amount 115. The aggregation period may be predefined (e.g., one minute, one hour, one day) or selected dynamically based upon a number of transfers 110 received over time. Further, since movement of funds 114 is predominantly within the same financial area 104, the cost of transferring funds 112, 114 is negligible or zero, such as when entities 106 utilize the same financial institution 108.

FIG. 3B shows ledger 280(1) of FIG. 2 in exemplary detail for an aggregation period 350 (i.e., the aggregation period of transfers 110 shown in FIG. 1). Ledger 280(1) stores information of each transfer 110(1)-(3) (e.g., sender ID 302, receiver ID 306, pre-conversion amount 312, source currency 314, destination currency 316, exchange rate 318, financial areas 104, and information of financial institutions 108 for the identified entities), and information of correspondingly generated send components 224, receive components 226, and agreed exchange rates 319, that define the actual transfers performed by servers 102 to implement the transfer of funds, and also include information of any needed aggregate transfer 116 between the servers 102. That is, ledger 280 stores information of all transfers handled by servers 102(1) and 102(2) to implement transfers 110 for each aggregation period (e.g., aggregation period 350). Through information within send components 224 and receiver components 226, ledger 280 correlates entities 106 with their financial institutions 108 that allows even further cost saving in transfers, as detailed in the following example.

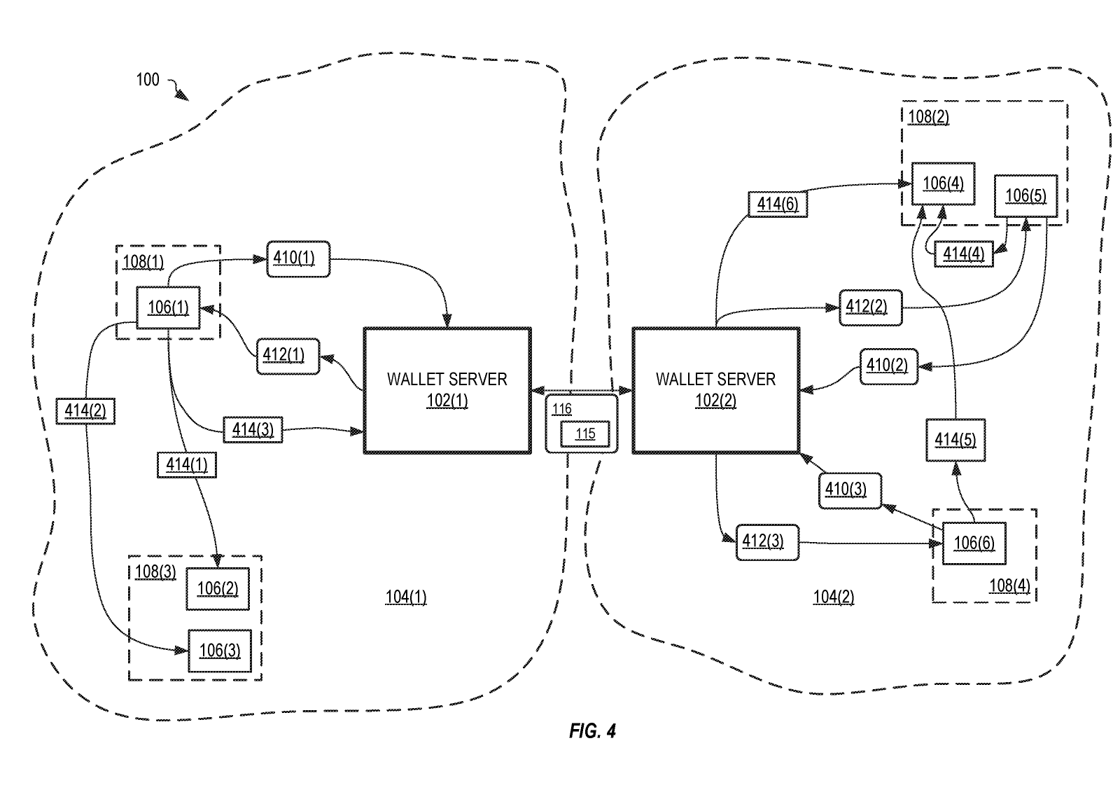

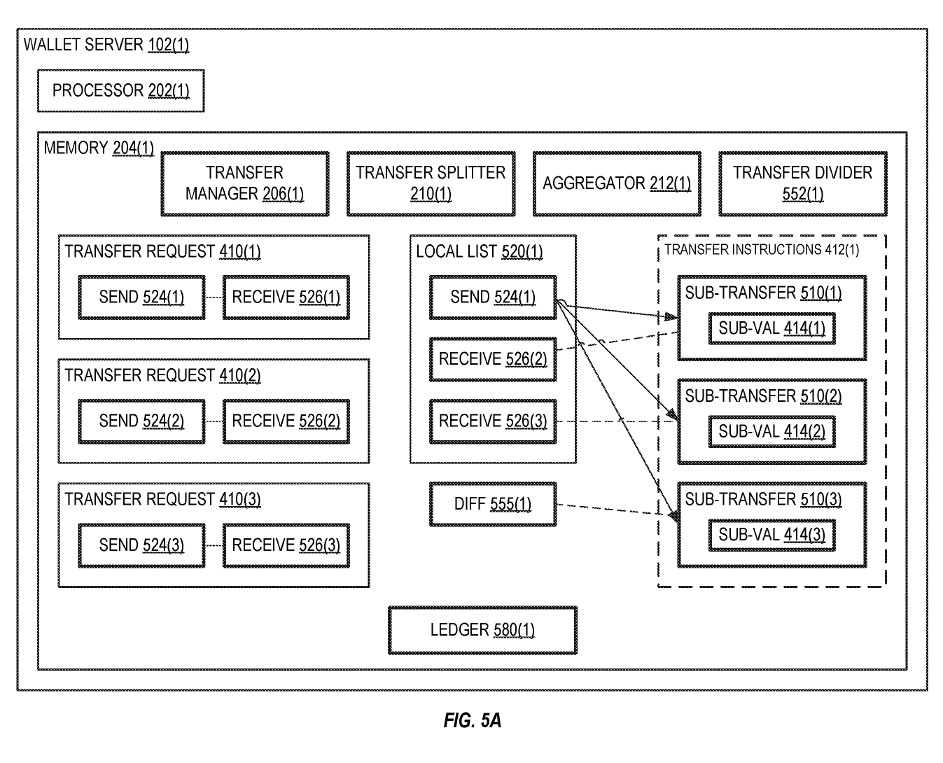

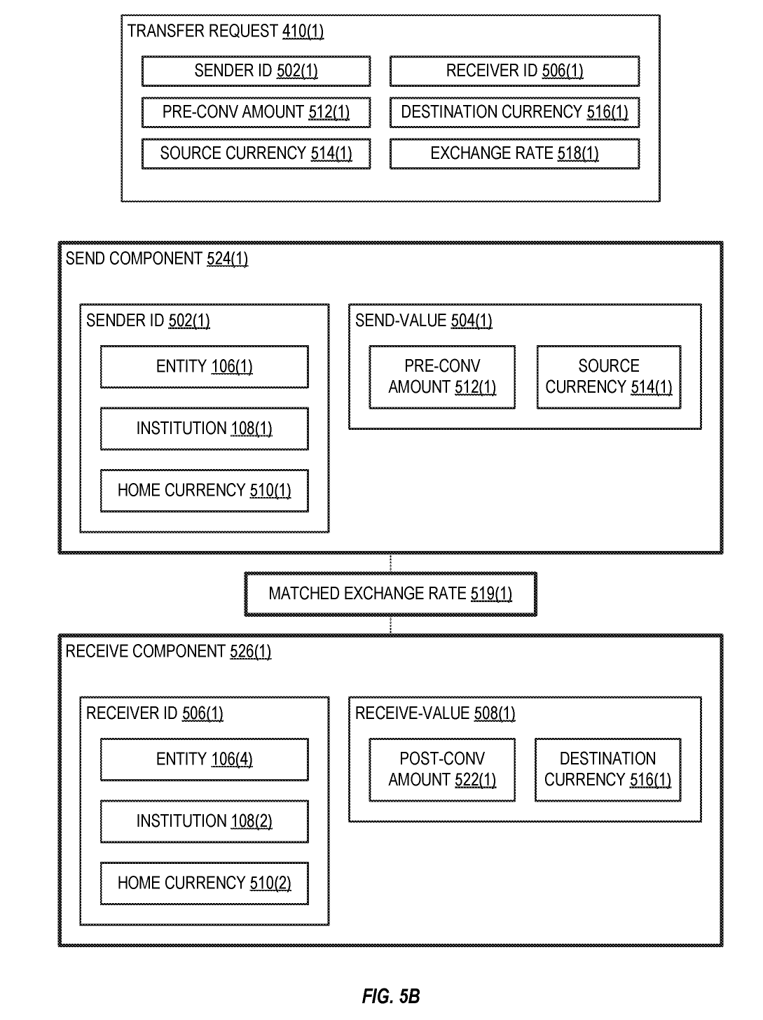

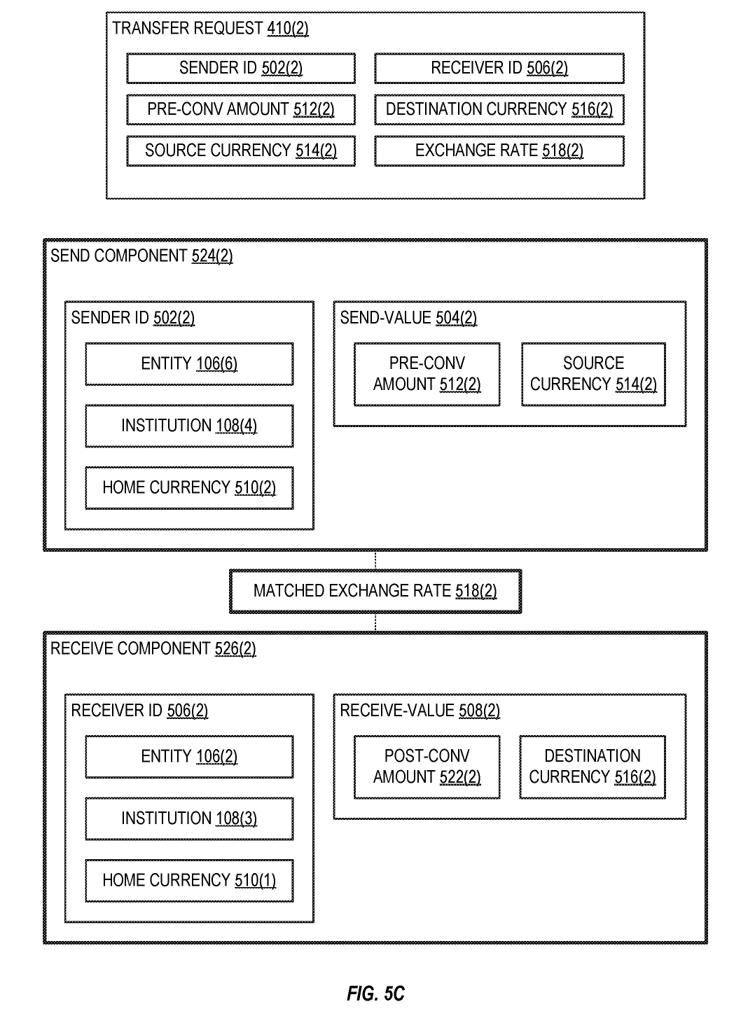

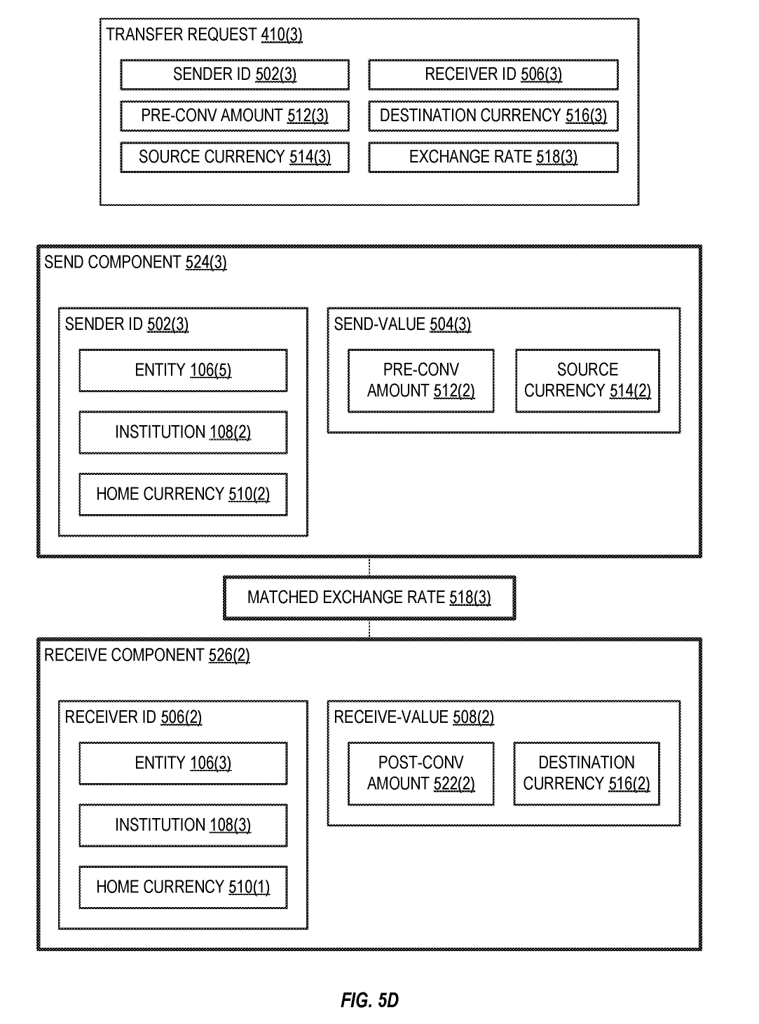

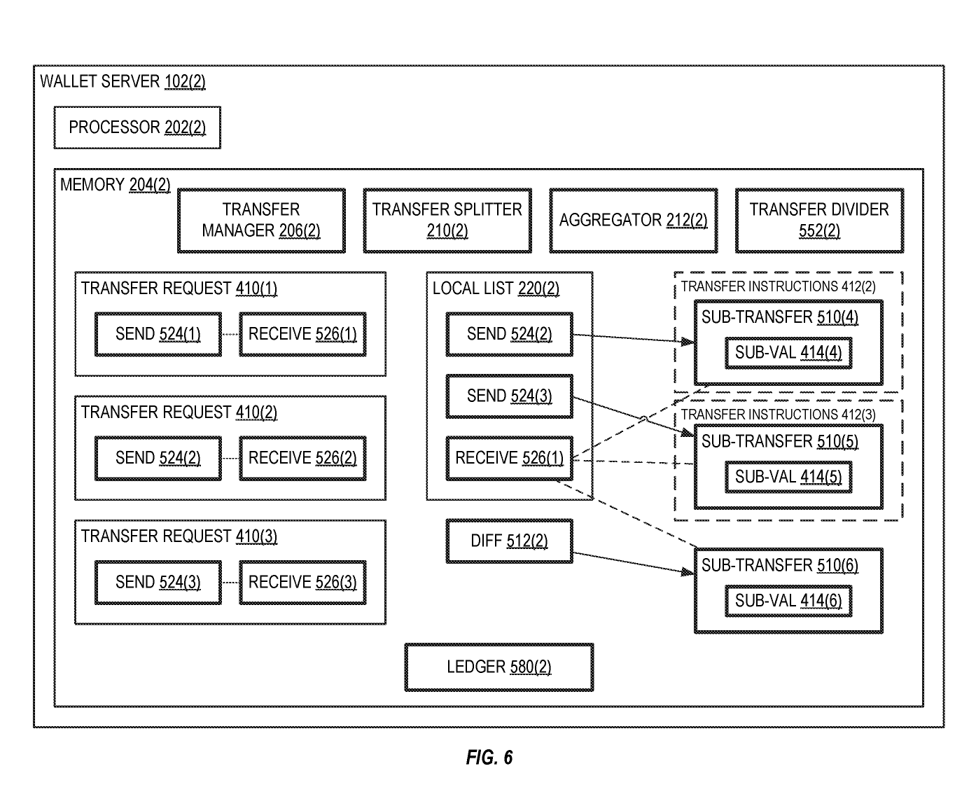

FIG. 4 shows one example scenario where transfers to and from each entity 106 are further subdivided such that all funds are not transferred through servers 102, and are more optimally and cost effectively, transferred between entities 106 within each area 104 under control of wallet servers 102. Servers 102 include functionality previously described with reference to FIG. 2, and include additional functionality as described below. FIGS. 5A and 6 show wallet servers 102(1) and 102(2) of FIG. 1 each further configured with a transfer divider 552(1) and 552(2), respectively, that divide components 524, 526 corresponding to transfer requests 410 into multiple sub-transfers 510. FIGS. 5B-D shows example data of the transfer requests 410 of FIG. 4 and corresponding send components 524 and receive components 526. FIGS. 4 through 6 are best viewed together with the following description.

In this example, transfer requests 410 of FIG. 4 are similar to transfers 110 of FIG. 1, but do not include funds of the transfer request. That is, the funds are not immediately sent to server 102. For example, entity 106(1), in area 104(1), sends a transfer request 410(1) to server 102(1) requesting transfer of funds 112(1) (e.g., five-hundred dollars or thirty-thousand Rupees) to entity 106(4) in area 104(2). At the same time, entity 106(6) in area 104(2) sends a transfer request 410(2) to server 102(2) requesting transfer of funds 112(3) (e.g., six-thousand Rupees or one-hundred dollars) to entity 106(2) in area 104(1), and entity 106(5) in area 104(2) sends a transfer request 410(3) to server 102(2) requesting transfer of funds 112(3) (e.g., eighteen-thousand Rupees or three-hundred dollars) to entity 106(3) in area 104(1).

As with the embodiment of FIG. 2, within each server 102, transfer splitter 210 processes each transfer request 410 and generates send component 524 and receive component 526. Then, aggregator 212 separates send components 524 and receive components 526 into a local list 520, and optionally an external list, depending upon which server 102(1) 102(2) will handle control of the corresponding transfers.

Within each server 102, a transfer divider 552, implemented as machine readable instructions stored in memory 204 and executed by processor 202, processes each component 524, 526 to generate one or more sub-transfers 510.

Upon receiving, during an aggregation period 850 (e.g., dynamically determined, one minute, on hour, one day), transfer requests 410 within servers 102(1) and 102(2), servers 102(1) and 102(2) cooperate to determine an optimal set of sub-transfers 510 between entities 106 within each area 104 to fulfill the transfer requests. Within server 102(1), using local list 520(1), transfer divider 552(1) divides send component 524(1) into sub-transfers 510(1)-(3), where sub-transfer 510(1) corresponds to receive component 526(2), sub-transfer 510(2) corresponds to receive component 526(3), and sub-transfer 510(3) corresponds to difference 555(1) between send-value 504 of send component 524(1) and a sum of receive-values 508 of receive components 526(2) and 226(3). Within server 102(2), using local list 520(2), transfer divider 552(2) uses send component 524(2) for sub-transfers 510(4), send component 524(3) for sub-transfer 510(5), and a difference 555(2) between send-value 504 of send components 524(2) and 524(3) and receive-values 508 of receive component 526(1) to form sub-transfer 510(6). Sub-transfers 510(4)-(6) combine to form the necessary fund transfers to complete receive component 526(1).

Accordingly server 102(1) sends transfer instructions 412(1) for sub-transfers 510(1)-(3) to entity 106(1), and server 102(2) sends transfer instructions 412(2) for sub-transfer 510(4) to entity 106(5) and transfer instructions 412(3) for sub-transfer 510(5) to entity 106(6). Sub-transfer 510(6) is handled by server 102(2) upon receipt of aggregate amount 115 from server 102(1), which, in this example, corresponds to sub-transfer 510(3) from entity 106(1) to server 102(1). In certain embodiments, transfer instructions 412 automatically initiate the transfer(s) defined therein. For example, transfer instructions 412(1) may instruct financial institution 108(1) to transfer funds 414(1)-(3) to entities 106(2) and (3), respectively, and to transfer funds 414(3) to server 102(1), each transfer being pre-approved by entity 106(1) when sending transfer request 410(1).

Specifically, for the above example, transfer instructions 412(1) instructs entity 106(1) to send funds 414(1) of one-hundred dollars to entity 106(2), funds 414(2) of three-hundred dollars to entity 106(3), and funds 414(3) of one-hundred dollars to server 102(1). Transfer instructions 412(2) instructs entity 106(5) to send funds 414(4) of eighteen-thousand Rupees to entity 106(4), and transfer instructions 412(3) instructs entity 106(6) to send funds 414(5) of six-thousand Rupees to entity 106(4). Server 102(2) also sends funds 414(6) of six-thousand Rupees to entity 106(4), for example after receiving aggregate amount 115 from server 102(1).

As shown in FIG. 5B, send-value 504(1) of send component 524(1) is greater than the sum of receive-values 508 of receive components 526(2) and 526(3) and thus send component 524(1) is divided into sub-transfers 510(1) and 510(2) that fulfill receive component 526(2) and 526(3), respectively. Where send-value 504 of send component 524 is not sufficient to fulfill any one receive component 526, the receiving entity 106 receives multiple sub-transfers 510 to complete that receive component 526. See for example receive component 526(1) that is fulfilled by sub-transfers 510(4)-(6).

Within each server 102, transfer splitter 210, aggregator 212, and transaction divider 552 cooperate to complete all transfer requests 410 received within that aggregation period 850 with the fewest number of, and/or most cost effective, sub-transfers 510.

Each server 102 utilizes ledger 580 to record each transfer and/or each sub-transfer for each transfer request 410. Ledger 580 may be centrally located (e.g., within a specific server) or distributed (e.g., where ledger 580 is implemented as a BlockChain structure).

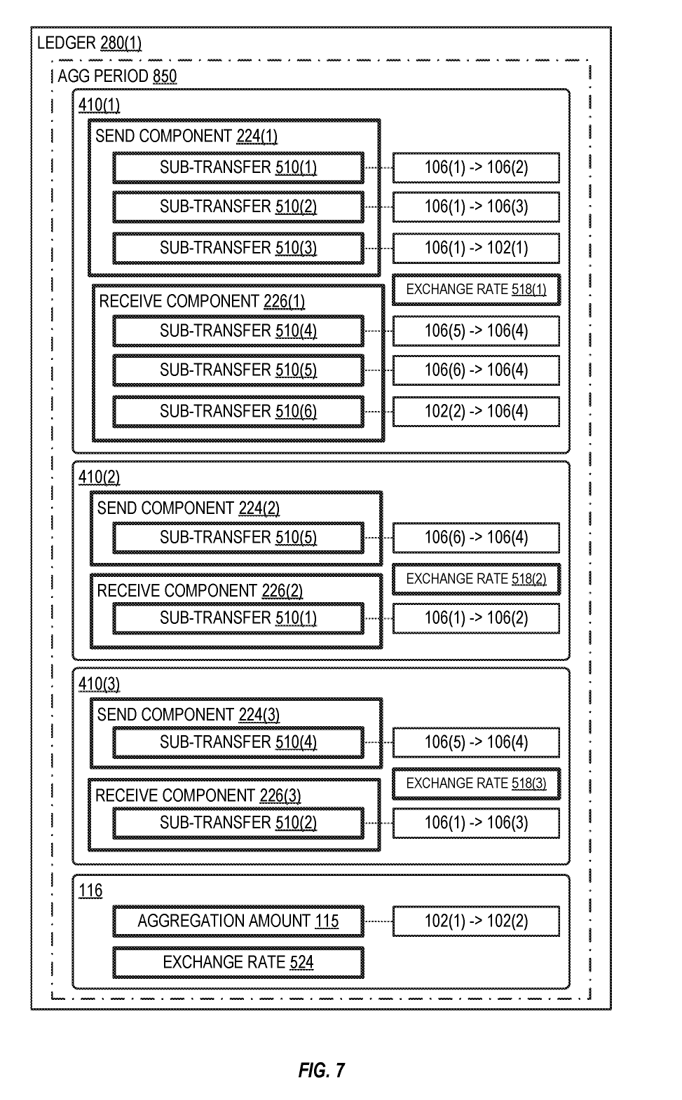

FIG. 7 shows ledger 280(1) of FIG. 5A storing implemented sub-transfers 510 based upon transfer requests 410 of FIGS. 4, 5 and 6. As shown, ledger 280(1) stores each transfer request 410, corresponding exchange rates 518, all sub-transfers 510 that implement each transfer request 410, the associated entities 106 involved in the sub-transfers, and aggregated transfer 116. Ledger 280 thereby allows system 100 to provide complete traceability of monetary transfers and conform to regulatory requirements.

In one embodiment, for each aggregation period, servers 102 cooperate to reduce each of a plurality of transfer between two different financial areas 104 into as few as possible transfers within each of the areas 104. By doing this, at least the following advantages are achieved:
The cost of transferring funds is reduced, since the majority of funds remain within their originating financial area 104.
The expense of currency exchange is reduced since the majority of funds remain within their originating financial area 104.
Transfer of funds between financial areas may be expedited and low cost, since the number of transfers between different financial areas 104 is reduced.
There is no need to use a correspondent bank for most transfers, since the majority of funds remain within their originating financial area 104.
The amount of funds transferred between different financial areas is reduced
A central and/or distributed ledger tracks each transfer and sub-transfer.

Servers 102 may be configured to fully automate the transfer of funds, thereby allowing transfer between two different financial areas 104 substantially immediate and operable at all times (since most transfers result in one or more transfers within one financial area). Where a transfer is between two entities that utilize the same financial institution 108, the cost of the transfer is often negligible or free.

### Cash Transfers

In one embodiment, servers 102 implement cash transfers (e.g., similar to wire transfers of Western Union, etc.). For example, where entity 106(1) wishes to send cash to entity 106(4), servers 102 cooperate, as described above to effect the transfer of funds, but entities 106(5) and 106(6) are selected (e.g., based upon location and/or availability) such that they may deliver cash to entity 106(4) rather than make a transfer of funds. Thus, entity 106(4) receives cash from entity 106(1) without incurring conversion or chargeback costs.

### Currency Conversion

Since each transfer request 410 is from a first financial area 104 to a different financial area 104, a currency conversion may also be required when determining the value of funds to deliver to the recipient of the transfer request. In the above example, currency conversion occurs at a fixed rate of one dollar to sixty Rupees for both conversion directions (i.e., dollars to Rupees and Rupees to dollars). That is, even though funds may not actually be transferred between financial areas due to aggregation by system 100, a value of the transferred funds in the destination financial area is determined in the currency of that financial area (or in the currency desired by the recipient or sender). In the above example, where entity 106(1) sends five-hundred US dollars from the US to entity 106(4) in India, thirty-thousand Rupees (equivalent to five-hundred dollars at the one dollar to sixty Rupee exchange rate) is transferred to entity 106(4). An inverse exchange rate of sixty Rupees to one dollar is used for funds being transferred from financial area 104(2) (e.g., India) to financial area 104(1) (e.g., USA). In this embodiment, the exchange rate used to determine the value of funds for each transfer is determined by server 102 as an average amount for a predefined period (e.g., aggregation period 850 or longer).

However, the exchange rate in one direction between two currencies (i.e., between two financial areas 104) need not be an inverse for the other direction. In one embodiment, entities requesting a transfer within the aggregation period (e.g., entities 106(1), 106(5) and 106(6)) may each bid on an exchange rate (i.e., specify their preferred exchange rate), and only when the exchange rates are agreed by all requesting entities (i.e., between entities 106(1), 106(5) and 106(6)) do the transfers occur. For example, where entity 106(5) offers a better exchange rate than entity 106(6), entity 106(1) and/or server 102 may select entity 106(5) to transfer at least part of funds 112(1) to entity 106(4). Where an entity is requesting an exchange rate that is favorable for their transfer, that exchange rate will be less favorable to transfers in the opposite direction. Where the exchange rate for the opposite direction is less favorable, the transfer is less likely to occur. Thus, the exchange rate offered/requested by each entity should take into account the urgency of their own transfer against the likelihood of an entity in the other financial area also agreeing to that exchange rate. For example, where one entity has urgency to make a transfer, they are more likely to accept a less favorable exchange rate for that transfer, thereby allowing an entity in the receiving financial area to have a more favorable exchange rate.

In one embodiment, within transfer request 410, entity 106 specifies both a buy and a sell exchange rate, or a middle exchange rate with a delta (e.g., one dollar to sixty three Rupees, +/−5%), wherein the sell exchange rate is used when matching transfers within the destination area, and the buy exchange rate is used when matching transfers within the source area. For example, servers 102(1) and (2) may implement an auction style algorithm that allows entities 106 to bid on the exchange rate between areas 104(1) and 104(2), whereby entities bidding with a less favorable exchange rate are less likely to be accepted for aggregation as compared to entities bidding with a more favorable exchange rate. Thus, entities bidding with less favorable exchange rates may wait longer for their funds to transfer as compared to entities bidding with more favorable exchange rates. Servers 102(1) and (2) may cooperate to group transfer requests based upon the exchange rate bid for those transfers. In one embodiment, servers 102 cooperate to balance the exchange rates on a daily basis.

In the embodiment where servers 102 implement buy and sell exchange rates between each pair of financial areas, a difference between the buy and sell exchange rates allows a commission to be earned by servers 102, even when there is no currency conversion for the transfer. Even though there is no actual currency conversion requirement when funds stay within the same financial area, the exchange rate used for each transfer. In certain embodiment, a charge for currency conversion for each transfer request 410 may be made by servers 102.

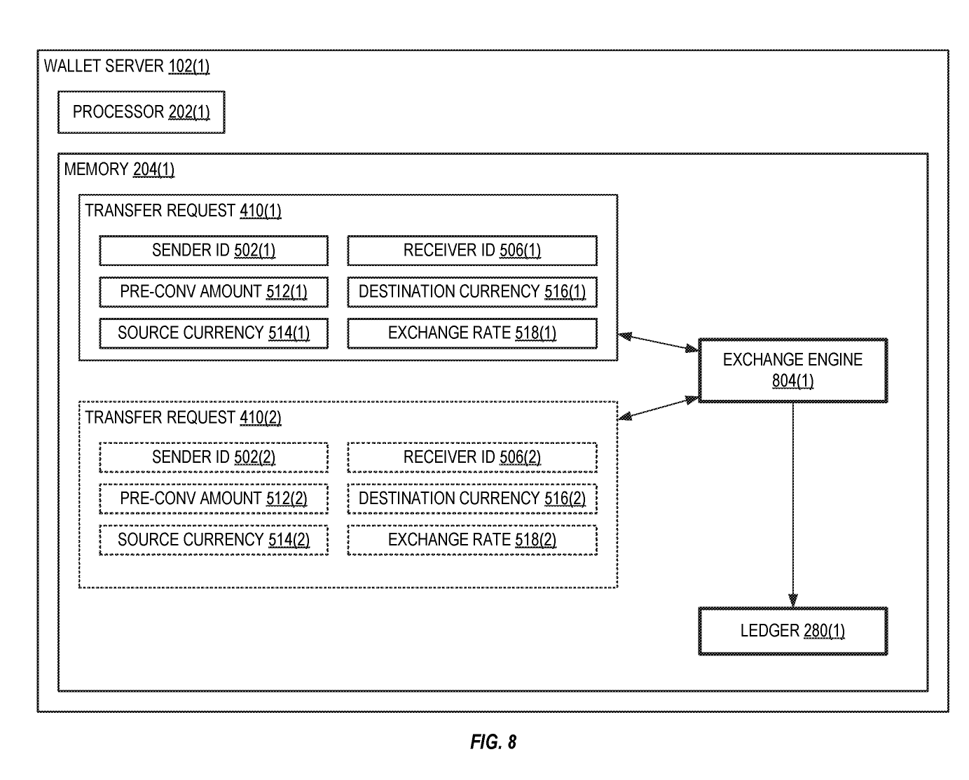

FIG. 8 shows wallet server 102(1) configured with an exchange engine 804(1) that, for each aggregation period, matches transfer requests 410 within each financial area 104 for each aggregation period. Continuing with the example of FIG. 4, transfer request 410(1) is received by server 102(1) from entity 106(1) and is shown stored within memory 204(1) of server 102(1). Transfer request 410(1) defines an amount to transfer (e.g., pre-conversion amount 512(1)) and a preferred exchange rate (e.g., exchange rate 518(1)). Wallet server 102(1) also receives, via server 102(2), transfer request 410(2), also shown stored within memory 204(1).

In one embodiment, exchange engine 804(1) matches exchange rate 518(1) to exchange rate 518(2) (taking into account that exchange rate 518(2) is the inverse of exchange rate 518(1)) to determine that entities 106(1) and 106(5) may cooperate to perform at least part of the required currency exchange to fulfill transfer requests 410(1) and 410(2). Where transfer request 410 includes buy and sell exchange rates or a delta, exchange engine 804(1) matches buy to sell exchange rates accordingly. It should be noted that these currency exchanges are not limited to transfer requests involving the same entities. I.e., the source and destination entities 106 of transfer requests 410 do not have to match—just exchange rates 518. Any transfer request having the appropriate exchange rate between the source currency and the destination currency may be matched.

In this example, the post-conversion amount 522(2) (i.e., after pre-conversion amount 512(2) is converted) of transfer request 410(2) is less than the pre-conversion amount 512(1) of transfer request 410(1), and thus exchange engine 804(1) matches additional transfer requests (e.g., transfer request 410(3)) to fulfill the currency exchange required for transfer request 410(1). Exchange engine 804(1), by matching exchange rates 518 and fulfilling currency conversions for pre-conversion amount 512 of at least two transfer requests 410, exchange engine 804(1) identifies entities 106 to fulfill each send component 524, receive component 526, and sub-transfers 510 to complete each transfer request 410. Where less than all of pre-conversion amount 512 of a transfer request 410 is converted (i.e., there is a resulting aggregation amount 115), exchange engine 804(1) and/or servers 102 may exchange and transfer this aggregation amount 115 using conventional currency conversion and transfer mechanisms. For example, operators of servers 102 may act as currency brokers (market makers) and define an exchange rate for transferring the aggregate amount 115. Further, the operators of servers 102 may also make a charge for each currency conversion of transfer requests 410, even when no conversion charge is actually incurred by servers 102 because of aggregation.

Where entity 106 sets exchange rate 518 as overly favorable for their transfer request, the probability of the exchange rate being matched by exchange engine 804(1) is reduced, resulting in the transfer request 410 being delayed or not being fulfilled within the current aggregation period, wherein it remains within system 100 for subsequent aggregation periods until fulfilled or is cancelled or modified by the requesting entity. Since transfer request 410(1) is matched by transfer requests 410(2) and 410(3), pre-conversion amount 512(1) may have multiple different exchange rates based upon exchange rates 518(2) and 518(3) offered by transfer requests 410(2) and 410(3).

Exchange rates 518 may also be defined dynamically. For example, entity 106(5) may define exchange rate 518(2) as being sixty Rupees to one dollar for one day, then increasing linearly over the next two days to sixty-six Rupees to one dollar. Thus, if a match is found by exchange engine 804(1) within that first day, entity 106(5) receives a better exchange rate as compared to when no match is found and the exchange rate is increased. Entities 106 may thus define exchange rate 518 based upon the urgency of their transfer.

In one embodiment, entity 106 interacts with server 102 and/or exchange engine 804 to determine an acceptable exchange rate 518. For example, where exchange engine 804 finds no match to the requested exchange rate 518 for transfer request 410, entity 106 may interactively lower exchange rate 518 over time until it is matched. In another embodiment, where exchange engine 804 finds no match to the requested exchange rate 518, exchange engine 804 may interactively provide entity 106 with a list of available exchange rates that entity 106 may agree to (e.g., by selecting one or more) for their transfer request 410.

In another example (not shown) where there are three or more transfer requests between three or more different financial areas, some transfers may be aggregated within each financial area whereas one or more entities my agree to settle on an independent currency exchange and transfer of funds to ensure that these transfers complete. In each case, ledger 280 records and tracks each currency conversion and transfer for each transfer request, thereby providing full traceability of the funds to meet legal requirements.

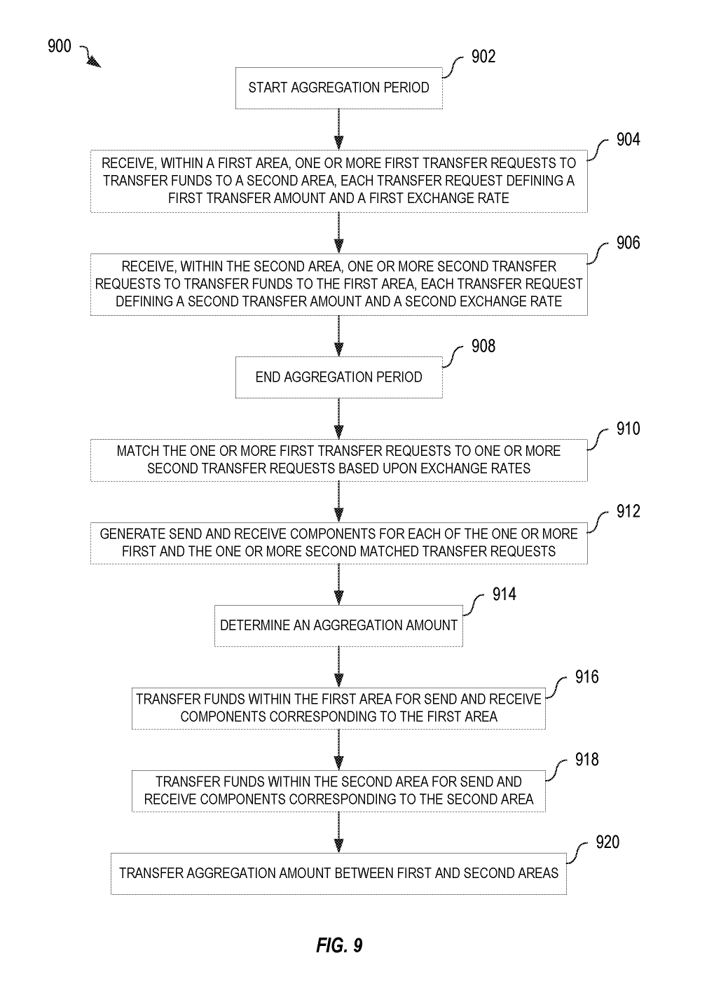

FIG. 9 is a flowchart illustrating one exemplary method 900 for aggregating transfer of funds between financial areas. In step 902, method 900 starts an aggregation period. In one example of step 902, servers 102(1) and 102(2) simultaneously start a timer to measure an aggregation period. In step 904, method 900 receives, within a first area, one or more first transfer requests to transfer funds to a second area, each transfer request defining a first transfer amount and a first exchange rate. In one example of step 904, server 102(1) within financial area 104(1) receives transfer request 410(1). In step 906, method 900 receives, within the second area, one or more second transfer requests to transfer funds to the first area, each transfer request defining a second transfer amount and a second exchange rate. In one example of step 906, server 102(2) within financial area 104(2) receives transfer requests 410(2) and 410(3). In step 908, method 900 ends the aggregation period. In one example of step 908, servers 102(1) and 102(2) simultaneously end the aggregation period.

In step 910, method 900 matches the one or more first transfer requests to one or more second transfer requests based upon exchange rates. In one example of step 910, exchange engine 804 matches exchange rate 518(1) of transfer request 410(1) to exchange rates 518(2) and 518(3) of transfer requests 410(2) and 410(3), respectively.

In step 912, method 900 generates send and receive components for each of the one or more first and the one or more second matched transfer requests. In one example of step 912, transfer splitter 210(1) generates send component 524(1) and receive component 526(1) for transfer request 410(1), generates send component 524(2) and receive component 526(2) for transfer request 410(2), and generates send component 524(3) and receive component 526(3) for transfer request 410(3).

In step 914, method 900 determines an aggregate amount. In one example of step 914, aggregator 212(1) determines difference 555(1) by subtracting a sum of receive-values 508 of receive components 526(2) and 226(3) from send-value 504 of send component 524(1) to determine aggregation amount 115. In step 916, method 900 transfers funds within the first area or send and receive components corresponding to the first area. In one example of step 916, transfer divider 552(1) determines sub-transfers 510(1)-(3) corresponding to send component 524(1) and instructs entity 106(1) to make these sub-transfers. In step 918, method 900 transfers funds within the second area for send and receive components corresponding to the second area. In one example of step 918, transfer divider 552(2) determines sub-transfers 510(4) and 510(5) corresponding to send components 524(2) and 524(3) and instructs entities 106(5) and 106(6) to make these sub-transfers. Transfer divider 552(2) then determines sub-transfer 510(6) corresponding to receive component 526(1). In step 920, method 900 transfers aggregation amount between the first and second areas. In one example of step 920, sever 102(1) sends aggregation amount 115 to server 102(2).

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for aggregating transfer of funds between financial areas, comprising the steps of:
receiving, within first server located within a first financial area, a first transfer request to transfer funds from the first financial area to a second financial area;
communicating with a second server located in the second financial area to receive a second transfer request to transfer funds from the second financial area to the first financial area;
determining a first exchange rate for the first transfer request and a second exchange rate for the second transfer request;
determining an aggregation amount by aggregating the first and second transfer requests based upon the first and second exchange rates;
sending funds to a recipient within the first financial area based upon the second transfer request and the second exchange rate; and
transferring the aggregation amount between the first and second financial areas.

2. The method of claim 1, wherein the aggregation amount is less than the sum of values of both the first and the second transfer request.

3. The method of claim 1, wherein a portion of the value of the first transfer request is sent to the recipient without being exchanged between currencies.

4. The method of claim 1, wherein the aggregation amount is a difference between values of the first transfer request and the second transfer request based upon the first exchange rate and the second exchange rate.

5. The method of claim 1, the steps of receiving, communicating and determining being performed for an aggregation period for which the aggregation amount is determined.

6. A method for aggregating transfer of funds between financial areas, comprising the steps of:
receiving, within first server located within a first financial area, a first transfer request to transfer funds to a second financial area, the first transfer requests defining a first transfer amount and a first exchange rate;
receiving, within a second server located within the second financial area, a second transfer request to transfer funds to the first financial area, the second transfer request defining a second transfer amount and a second exchange rate;
matching the first transfer request to the second transfer request based upon the first exchange rate and the second exchange rate;
generating a first send component and a first receive component for the first transfer request and generating a second send component and a second receive components for the second transfer request;
determining an aggregation amount based upon the first and second send components and the first and second receive components;
transferring funds within the first area corresponding to the first send component and the second receive component;
transferring funds within the second area corresponding to the second send component and the first receive component; and
transferring the aggregation amount between the first and second areas.

7. The method of claim 6, the one or more first transfer requests and the one or more second transfer requests being received within an aggregation period coordinated between the first and second servers.

8. The method of claim 6, the step of transferring funds within the first area comprising sending first transfer instructions to a first entity within the first financial area corresponding to the first send request to transfer at least part of the funds of the first transfer requests to a second entity located within the first area and corresponding to the second transfer request.

9. The method of claim 6, the step of transferring funds within the second area comprising sending second transfer instructions to a third entity within the second financial area corresponding to the second send request to transfer at least part of the funds of the second transfer requests to a fourth entity located within the second area and corresponding to the first transfer request.

10. A wallet server for aggregating transfer of funds between a first financial area and a second financial area, comprising:
a processor;
a memory communicatively coupled with the processor;
a transfer splitter implemented as machine readable instructions stored within the memory and executed by the processor to split each received transfer request into a send component and a receive component, the transfer request requesting transfer of funds between the first and second financial areas;
an aggregator implemented as machine readable instructions stored within the memory and executed by the processor to:
match exchange rates between the first financial area and the second financial area; and
aggregate send components and receive components within the first financial area; and
a transfer manager implemented as machine readable instructions stored within the memory and executed by the processor to:
balance the received transfers between the first and second financial areas;
complete transfers deliverable within the first financial area; and
settle a balancing aggregation amount with the second financial area.
